(19) United States
(12) Patent Application Publication
(10) Pub. No.: US 2022/0324354 A1
(43) Pub. Date: Oct. 13, 2022

(54) METHOD OF CONTROLLING PASSENGER POSTURE OF AUTONOMOUS VEHICLE AND APPARATUS USING THE SAME

(71) Applicant: ELECTRONICS AND TELECOMMUNICATIONS RESEARCH INSTITUTE, Daejeon (KR)

(72) Inventors: Kyeong-Ho KIM, Daejeon (KR); Sang Wook LEE, Daejeon (KR)

(21) Appl. No.: 17/412,021

(22) Filed: Aug. 25, 2021

(30) Foreign Application Priority Data
Apr. 13, 2021 (KR) 10-2021-0047599

(51) Int. Cl. B60N 2/02; B60N 2/00; B60N 2/20; B60N 2/16

(52) U.S. Cl. CPC B60N 2/0248; B60N 2/002; B60N 2/20; B60N 2/1695; B60N 2002/0268; B60W 60/0013

(57) ABSTRACT

Disclosed herein are a method for controlling the posture of a passenger of an autonomous vehicle and an apparatus using the same. The method, performed by the apparatus, includes estimating the current state of the autonomous vehicle using multiple types of sensors installed in the autonomous vehicle, measuring the posture and the eye gaze of the passenger riding in the autonomous vehicle, estimating the next control information of the autonomous vehicle based on the autonomous operation information and the current state of the autonomous vehicle, detecting the optimal posture of the passenger in consideration of the next control information and of the posture and the eye gaze of the passenger, and controlling a seat such that the passenger matches the optimal posture.

### CROSS REFERENCE TO RELATED APPLICATION

This application claims the benefit of Korean Patent Application No. 10-2021-0047599, filed Apr. 13, 2021, which is hereby incorporated by reference in its entirety into this application.

### BACKGROUND OF THE INVENTION

### 1. Technical Field

The present invention relates generally to technology for controlling the posture of passengers who use an autonomous vehicle, and more particularly to technology for controlling the situation in which passengers riding in a self-driving car or an autonomous flight aircraft can be subjected to impact and for providing an optimized environment to the passengers.

### 2. Description of Related Art

With the advancement of autonomous driving technology, cars and aircrafts automatically moving without a pilot or a driver, drone taxies, urban air mobility (UAM) vehicles and the like have been realized, but when such vehicles are driven, passengers may feel anxiety depending on the movement of the vehicle bodies. For example, in the case of an airplane operated in the sky, it is important to maintain the flying attitude because unintended tilting thereof may disconcert passengers.

Accordingly, what is required is technology for maintaining the postures of passengers such that the passengers feel comfortable depending on the situation of an autonomous vehicle and maintaining the postures of the passengers depending on the eye gaze of the passengers in order to mitigate motion sickness. Also, in order to minimize vibration and shocks, technology for actively controlling the postures is urgently required.

### DOCUMENTS OF RELATED ART

(Patent Document 1) Korean Patent No. 10-2093915, registered on Mar. 20, 2020 and titled “Seat control method and apparatus for naval vessel console”.

### SUMMARY OF THE INVENTION

An object of the present invention is to calculate the optimal posture for actively providing the optimal onboard environment depending on the state of the body of an autonomous car or aircraft and on the posture and the eye gaze of a passenger and to perform control such that the posture of the passenger is changed to the optimal posture.

Another object of the present invention is to actively adjust the posture of a passenger riding in an autonomous vehicle, thereby offering comfort to the passenger.

A further object of the present invention is to significantly reduce damage in the event of an emergency and the anxiety that a passenger can feel when using an autonomous vehicle, thereby preventing unintended safety accidents.

Yet another object of the present invention is to correctly detect the current state of an autonomous vehicle body based not only on the measurement of the state of the autonomous vehicle body but also on measurement data on a surrounding environment and to predict the attitude of the autonomous vehicle body depending on the arranged operation route thereof, thereby providing an environment in which passengers can use the autonomous vehicle more safely.

In order to accomplish the above objects, a method for controlling the posture of a passenger according to the present invention includes estimating, by a passenger posture control apparatus, the current state of an autonomous vehicle using multiple types of sensors installed in the autonomous vehicle; measuring, by the passenger posture control apparatus, the posture and the eye gaze of a passenger riding in the autonomous vehicle; estimating, by the passenger posture control apparatus, next control information of the autonomous vehicle based on the autonomous operation information and the current state of the autonomous vehicle; detecting, by the passenger posture control apparatus, the optimal posture of the passenger in consideration of the next control information and of the posture and the eye gaze of the passenger; and controlling, by the passenger posture control apparatus, a seat such that the passenger matches the optimal posture.

Here, measuring the posture and the eye gaze may be configured to measure the posture and the eye gaze of the passenger based on the shape of the seat, an image sensor installed inside the autonomous vehicle, and a pressure sensor installed in the seat of the passenger.

Here, controlling the seat may be configured to calculate seat control parameters for achieving the optimal posture and to control the seat so as to match the seat control parameters.

Here, estimating the current state may include collecting information about the attitude of the autonomous vehicle based on the multiple types of sensors; collecting information about an environment around the autonomous vehicle based on the multiple types of sensors; and estimating the current state based on the information about the attitude and the information about the environment.

Here, the information about the attitude may include the roll, the pitch, and the yaw of the body of the autonomous vehicle.

Here, the information about the environment may include the atmospheric pressure, the location information, and the weather information pertaining to the vicinity of the autonomous vehicle.

Here, controlling the seat may be configured to detect the optimal posture at a preset control period and to control, when the optimal posture is changed, the seat so as to match the changed optimal posture.

Here, controlling the seat may be configured to, when a change equal to or greater than a preset reference change rate occurs in the current state of the autonomous vehicle, control the seat so as to match an optimal posture, which is extracted in consideration of the change in the current state.

Here, controlling the seat may be configured to control at least one of the tilt of each part of the seat and the height of the seat.

Also, an apparatus for controlling the posture of a passenger according to an embodiment of the present invention includes a processor for estimating the current state of an autonomous vehicle using multiple types of sensors installed in the autonomous vehicle, measuring the posture and the eye gaze of a passenger riding in the autonomous vehicle, estimating the next control information of the autonomous vehicle based on the autonomous operation information and the current state of the autonomous vehicle, detecting the optimal posture of the passenger in consideration of the next control information and of the posture and the eye gaze of the passenger, and controlling a seat such that the passenger matches the optimal posture; and memory for storing at least one of the current state, the next control information, and the optimal posture.

Here, the processor may measure the posture and the eye gaze of the passenger based on the shape of the seat, an image sensor installed inside the autonomous vehicle, and a pressure sensor installed in the seat of the passenger.

Here, the processor may calculate seat control parameters for achieving the optimal posture, and may control the seat so as to match the seat control parameters.

Here, the processor may collect information about the attitude of the autonomous vehicle based on the multiple types of sensors, collect information about an environment around the autonomous vehicle based on the multiple types of sensors, and estimate the current state based on the information about the attitude and the information about the environment.

Here, the information about the attitude may include the roll, the pitch, and the yaw of the body of the autonomous vehicle.

Here, the information about the environment may include the atmospheric pressure, the location information, and the weather information pertaining to the vicinity of the autonomous vehicle.

Here, the processor may check the optimal posture at a preset control period, and when the optimal posture is changed, the processor may control the seat so as to match the changed optimal posture.

Here, when a change equal to or greater than a preset reference change rate occurs in the current state of the autonomous vehicle, the processor may control the seat so as to match an optimal posture, which is extracted in consideration of the change in the current state.

Here, the processor may control at least one of the tilt of each part of the seat and the height of the seat.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating a system for controlling the posture of a passenger of an autonomous vehicle according to an embodiment of the present invention;

FIG. 2 is a view illustrating a system for controlling the posture of a passenger of an autonomous vehicle according to another embodiment of the present invention;

FIG. 3 is a flowchart illustrating a method for controlling the posture of a passenger of an autonomous vehicle according to an embodiment of the present invention;

FIG. 4 is a view illustrating the basic concept of autonomous driving control according to an embodiment of the present invention;

FIG. 5 is a view illustrating an example of modules configuring an apparatus for controlling the posture of a passenger of an autonomous vehicle according to the present invention;

FIG. 6 is a view illustrating an example of attitude information of an autonomous vehicle according to the present invention;

FIG. 7 is a view illustrating an example of seat control according to the present invention;

FIG. 8 is a flowchart illustrating in detail a method for controlling the posture of a passenger of an autonomous vehicle according to an embodiment of the present invention;

FIG. 9 is a block diagram illustrating an apparatus for controlling the posture of a passenger of an autonomous vehicle according to an embodiment of the present invention; and

FIG. 10 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

An autonomous vehicle may include an unmanned aerial vehicle, an autonomous car, and the like that are autonomously driving or autonomously operating in the state in which only passengers are riding in the vehicle, without a pilot or a driver. Also, although not yet developed, other transportation means that have yet to be developed in an autonomous driving form may be included therein.

Because such an autonomous vehicle has an environment that is different from that of a conventional transportation means operated by a driver, passengers may feel anxiety during the operation, and there is a risk of that lead to an accident.

Accordingly, the present invention intends to present a method for providing a comfortable onboard environment while maintaining the postures of passengers in order to prevent the passengers from feeling anxiety.

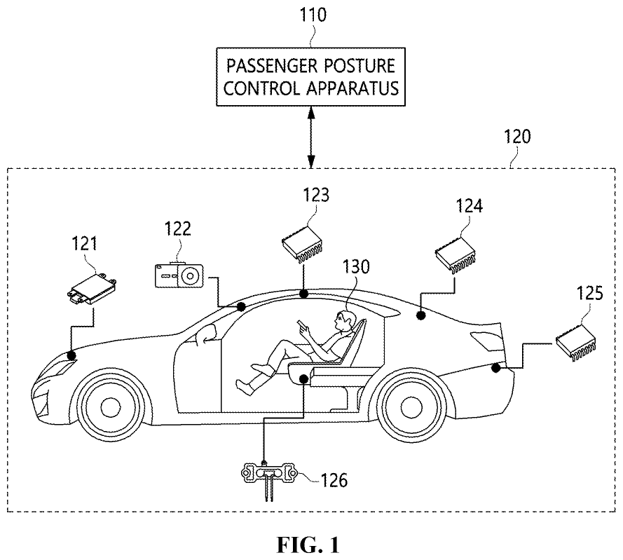

FIG. 1 is a view illustrating a system for controlling the posture of a passenger of an autonomous vehicle according to an embodiment of the present invention.

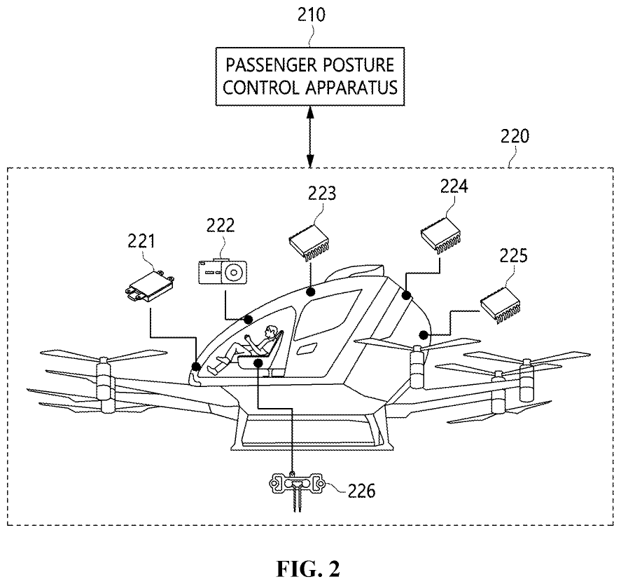

FIG. 2 is a view illustrating a system for controlling the posture of a passenger of an autonomous vehicle according to another embodiment of the present invention.

Referring to FIGS. 1 to 2, the system for controlling the posture of a passenger of an autonomous vehicle according to an embodiment of the present invention includes a passenger posture control apparatus 110 or 210 and an autonomous vehicle 120 or 220, which carries a passenger 130 and in which multiple types of sensors 121 to 126 or 221 to 226 are installed.

The passenger posture control apparatus 110 or 210 estimates the current state of the autonomous vehicle 120 or 220 based on the multiple types of sensors 121 to 126 or 221 to 226 installed in the autonomous vehicle 120 or 220.

Here, information about the attitude of the autonomous vehicle 120 or 220 is collected using the multiple types of sensors 121 to 126 or 221 to 226, information about the environment around the autonomous vehicle 120 or 220 is collected using the multiple types of sensors 121 to 126 or 221 to 226, and the current state may be estimated based on the attitude information and the environment information.

Here, the attitude information may include the roll, pitch, and yaw of the body of the autonomous vehicle 120 or 220.

Here, the environment information may include the atmospheric pressure, the location information, and the weather information pertaining to the vicinity of the autonomous vehicle 120 or 220.

Also, the passenger posture control apparatus 110 or 210 measures the posture and the eye gaze of the passenger 130 riding in the autonomous vehicle 120 or 220.

Here, the posture and the eye gaze of the passenger 130 may be measured based on the shape of a seat, the image sensor 122 or 222 installed inside the autonomous vehicle 120 or 220, and the pressure sensor 126 or 226 installed in the seat of the passenger 130.

Also, the passenger posture control apparatus 110 or 210 estimates the next control information pertaining to the autonomous vehicle 120 or 220 based on the autonomous operation information and the current state of the autonomous vehicle 120 or 220.

Also, the passenger posture control apparatus 110 or 210 detects the optimal posture of the passenger 130 in consideration of the next control information and of the posture and the eye gaze of the passenger 130, and controls the seat such that the passenger 130 takes the optimal posture.

Here, seat control parameters for achieving the optimal posture are calculated, and the seat may be controlled so as to match the seat control parameters.

Here, at least one of the tilt of each part of the seat and the height of the seat may be controlled.

Here, the optimal posture is detected at a preset control period, and when the optimal posture is changed, the seat may be controlled so as to match the changed optimal posture.

Here, when a change equal to or greater than a preset reference change rate occurs in the current state of the autonomous vehicle 120 or 220, the seat may be controlled so as to match the optimal posture, which is extracted in consideration of the change in the current state.

Here, although the passenger posture control apparatus 110 or 210 is illustrated as being located outside the autonomous vehicle 120 or 220 in FIGS. 1 and 2, the passenger posture control apparatus 110 or 210 may operate in the state of being located inside the autonomous vehicle 120 or 220.

Also, although six types of sensors 121 to 126 or 221 to 226 are illustrated in FIGS. 1 and 2, a greater number of types of sensors may be provided at more diverse locations in the vehicle body depending on the type of the autonomous vehicle 120 or 220.

Through the above-described system for controlling the posture of a passenger of an autonomous vehicle, the posture of the passenger riding in the autonomous vehicle may be actively adjusted so as to provide comfort to the passenger, and damage in the event of an emergency or the anxiety that a passenger can feel when using the autonomous vehicle may be significantly reduced, so that unintended safety accidents may be prevented.

Also, the autonomous vehicles 120 and 220 are illustrated as an autonomous car and a drone taxi in FIG. 1 and FIG. 2, but without limitation thereto, the autonomous vehicle may be any of various transportation means to be developed.

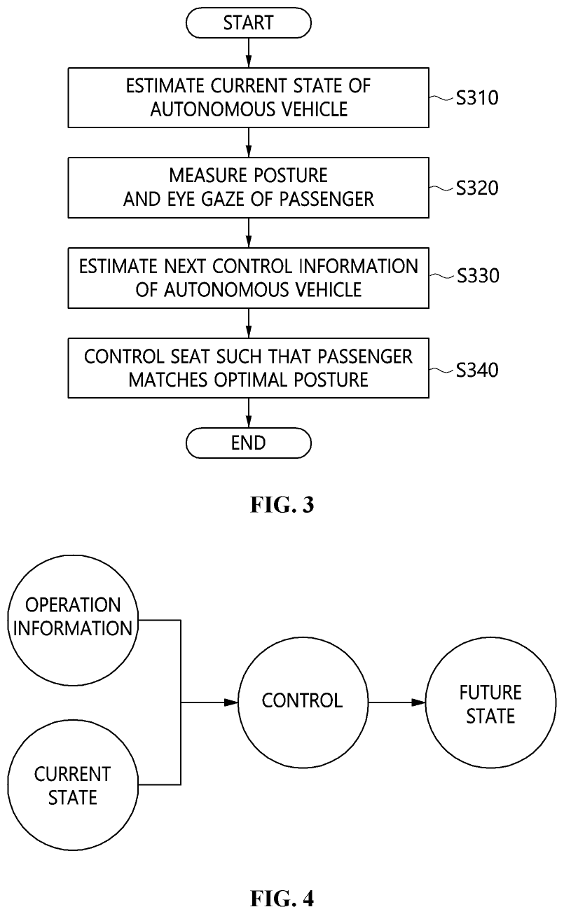

FIG. 3 is a flowchart illustrating a method for controlling the posture of a passenger of an autonomous vehicle according to an embodiment of the present invention.

Referring to FIG. 3, in the method for controlling the posture of a passenger of an autonomous vehicle according to an embodiment of the present invention, a passenger posture control apparatus may estimate the current state of the autonomous vehicle based on multiple types of sensors installed in the autonomous vehicle at step S310.

Here, the autonomous vehicle may include a transportation means to which an autonomous driving system can be applied and in which seats for respective passengers are present, and an unmanned aerial vehicle, an autonomous driving car, and the like may be included in the category of autonomous vehicles.

First, the concept of autonomous driving will be described below with reference to FIG. 4. Autonomous driving is configured such that, when predefined operation information is present, the current state of the vehicle body and location information pertaining thereto are calculated using various types of sensors, and the difference from the next operation state is calculated, whereby control information for achieving the future state is calculated. Here, the operation is performed so as to achieve the future state by repeatedly performing control behavior.

The passenger posture control apparatus according to an embodiment of the present invention may operate based on such an autonomous driving operation form.

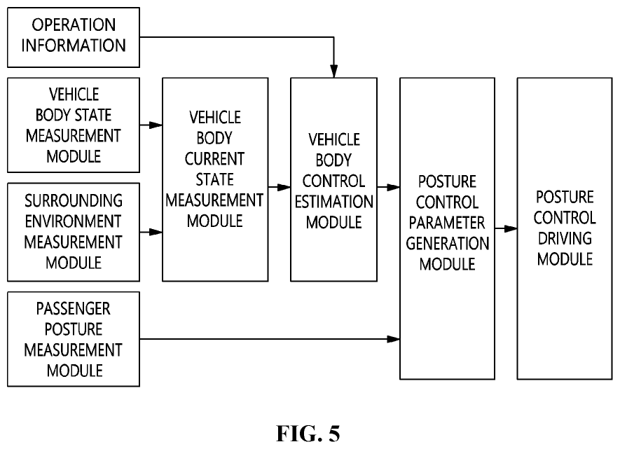

For example, the passenger posture control apparatus according to an embodiment of the present invention may operate based on the seven modules illustrated in FIG. 5.

Here, information about the attitude of the autonomous vehicle may be collected using the multiple types of sensors.

Here, the attitude information may include the roll, pitch, and yaw of the body of the autonomous vehicle.

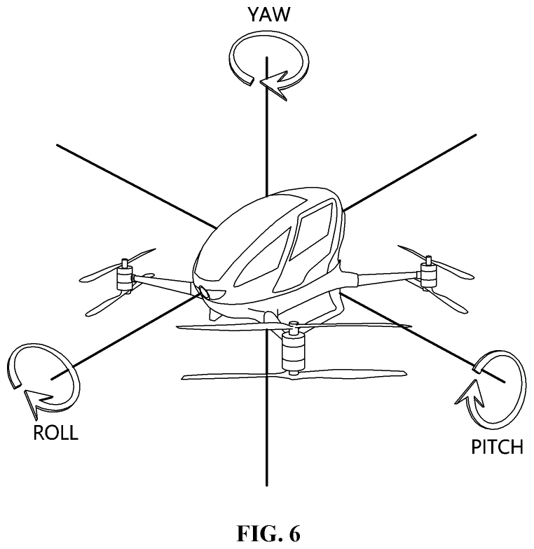

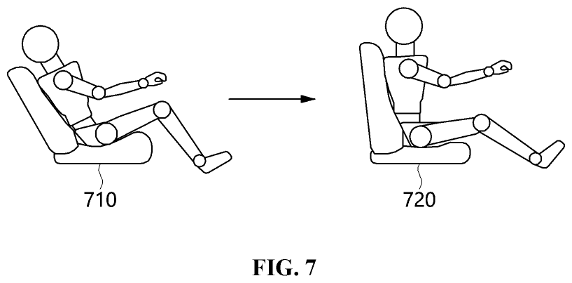

For example, the vehicle body state measurement module illustrated in FIG. 5 may measure the state of the body of the autonomous vehicle that is being operated. For example, in the case of an unmanned aerial vehicle, information about the attitude of the vehicle body, such as the roll, pitch, and yaw, and the speed of the autonomous vehicle body, may be collected, as shown in FIG. 6, using information acquired from the various types of sensors, such as the gyro sensor, the acceleration sensor, the magnetometer, and the like of the vehicle body.

Here, information about the environment around the autonomous vehicle may be collected using the multiple types of sensors.

Here, the environment information may include the atmospheric pressure, the location information, and the weather information pertaining to the vicinity of the autonomous vehicle.

For example, the atmospheric pressure, the location information, the weather information, and the like pertaining to the vicinity of the body of the autonomous vehicle that is being operated may be collected using the surrounding environment measurement module illustrated in FIG. 5.

Here, the current state may be estimated based on the attitude information and the environment information.

For example, the current state may be estimated by combining the attitude information and the environment information pertaining to the autonomous vehicle through the vehicle body current state estimation module illustrated in FIG. 5. As the result, the current attitude of the body of the autonomous vehicle may be detected, and the current state information in which the information about the environment around the autonomous vehicle is incorporated may be estimated.

Also, in the method for controlling the posture of a passenger of an autonomous vehicle according to an embodiment of the present invention, the passenger posture control apparatus measures the posture and the eye gaze of the passenger riding in the autonomous vehicle at step S320.

Here, the posture and the eye gaze of the passenger may be measured based on the shape of the seat, the image sensor installed inside the autonomous vehicle, and the pressure sensor installed in the seat of the passenger.

For example, the position of the seat is measured by measuring the current tilt angle, the rotation, and the like of the seat in which the passenger is sitting using the passenger posture measurement module illustrated in FIG. 5, whereby the posture of the passenger may be measured. Also, the actual sitting position of the passenger may be measured using the pressure sensor installed in the seat. Also, the accuracy of the posture may be compensated for based on the image information acquired using the camera installed inside the autonomous vehicle body, and information about the eye gaze of the passenger may be acquired based thereon.

Here, the scope of the sensors for measuring the posture and eye gaze of the passenger is not limited to the pressure sensor and the camera used in the example, and various technologies for measuring the posture and the eye gaze of a passenger may be applied.

Also, in the method for controlling the posture of a passenger of an autonomous vehicle according to an embodiment of the present invention, the passenger posture control apparatus estimates the next control information of the autonomous vehicle based on the autonomous operation information and the current state of the autonomous vehicle at step S330.

For example, the vehicle body control estimation module illustrated in FIG. 5 may estimate the next-step control operation of the vehicle body for achieving the future state of the autonomous vehicle, that is, the next control information, in consideration of the operation information and the current state of the autonomous vehicle.

Also, in the method for controlling the posture of a passenger of an autonomous vehicle according to an embodiment of the present invention, the passenger posture control apparatus detects the optimal posture of the passenger in consideration of the next control information and the posture and eye gaze of the passenger, and controls the seat such that the passenger matches the optimal posture at step S340.

Here, seat control parameters for achieving the optimal posture are calculated, and the seat may be controlled so as to match the seat control parameters.

Here, the seat control parameters may be calculated using the current state of the autonomous vehicle, the next control information pertaining thereto, and the posture and the eye gaze of the passenger.

Here, at least one of the tilt of each part of the seat and the height of the seat may be controlled.

For example, the posture control parameter generation module illustrated in FIG. 5 may generate seat control parameters for achieving the optimal posture of the passenger based on the current state of the autonomous vehicle body and the next control information for achieving the future state, which are delivered from the vehicle body control estimation module, and on the information about the posture and eye gaze of the passenger, which is delivered from the passenger posture measurement module.

Then, the function of operating each part of the seat in which the passenger is sitting may be performed using the posture control driving module illustrated in FIG. 5. For example, the motor mounted on the structure of the seat is driven so as to match the seat control parameters, whereby control, such as changing the tilt angle of the seat 710 or 720, as shown in FIG. 7, or changing the height of the seat, is performed. Accordingly, control may be performed such that the passenger who is sitting in the seat 720 takes the optimal posture.

Here, the optimal posture is detected at a preset control period, and when the optimal posture is changed, the seat may be controlled so as to match the changed optimal posture.

For example, the control period may be freely set or changed in consideration of the type of the autonomous vehicle or the operation route thereof.

Here, when a change equal to or greater than a preset reference change rate occurs in the current state of the autonomous vehicle, the seat may be controlled so as to match the optimal posture, which is extracted in consideration of the change in the current state.

For example, when the speed of the autonomous vehicle is rapidly changed, or when the weather conditions outside the autonomous vehicle suddenly become bad, the seat may be controlled so as to match the optimal posture, which is remeasured in consideration of the changed current state.

Here, the method of controlling the posture using the seat in the method for controlling the posture of a passenger according to an embodiment of the present invention is illustrated in order to help understanding, and a passenger may be prompted to take an optimal posture by controlling the entire room in which the passenger is seated or the attitude of the vehicle body in order to control of the posture of the passenger.

Through the above-described method for controlling the posture of a passenger of an autonomous vehicle, the optimal posture for actively providing the optimal onboard environment depending on the state of the body of an autonomous car or aircraft and on the posture and the eye gaze of the passenger may be calculated, and control may be performed such that the posture of the passenger is changed to the optimal posture.

Also, the current state of the vehicle body may be accurately detected based not only on the measurement of the state of the body of the autonomous vehicle but also on measurement data on the surrounding environment, and the attitude of the vehicle body is estimated depending on the arranged operation route, whereby an environment in which the passenger is able to use the autonomous vehicle more safely may be provided.

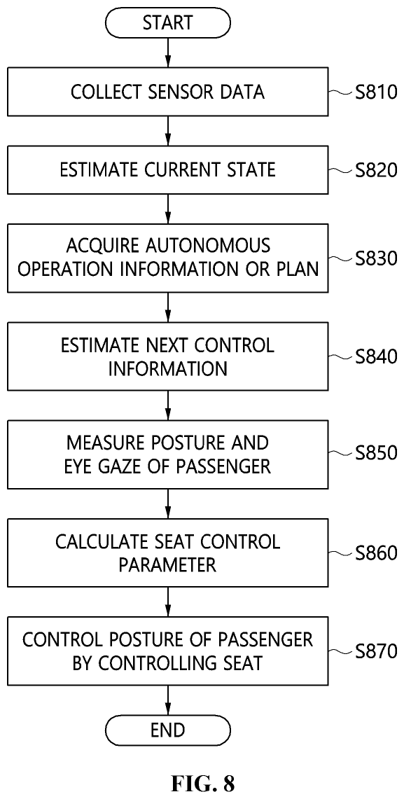

FIG. 8 is a flowchart illustrating in detail a method for controlling the posture of a passenger of an autonomous vehicle according to an embodiment of the present invention.

Referring to FIG. 8, in the method for controlling the posture of a passenger of an autonomous vehicle according to an embodiment of the present invention, first, when the operation or driving of the autonomous vehicle is started, sensor data may be collected at step S810 using multiple types of sensors in the autonomous vehicle.

Subsequently, the current state of the autonomous vehicle may be estimated at step S820 by combining attitude information and environment information pertaining to the autonomous vehicle, which are collected based on the sensor data.

Subsequently, the autonomous operation information or the autonomous operation plan of the autonomous vehicle is acquired at step S830, and the next control information of the autonomous vehicle for achieving the future state may be estimated at step S840 in consideration of the autonomous operation information or the autonomous operation plan, along with the current state of the autonomous vehicle.

Subsequently, the posture and the eye gaze of the passenger riding in the autonomous vehicle may be measured at step S850.

Here, the posture and the eye gaze of the passenger may be measured using the sensor data collected using the image sensor provided inside the autonomous vehicle or the pressure sensor installed in the seat in which the passenger is sitting.

Subsequently, seat control parameters are calculated at step S860 using the current state of the autonomous vehicle, the next control information pertaining thereto, and information about the posture and the eye gaze of the passenger, and the seat is controlled so at to match the seat control parameters, whereby control may be performed at step S870 such that the passenger takes the optimal posture.

The above-described process is continuously repeated during the operation of the autonomous vehicle, whereby the anxiety of the passenger riding in the autonomous vehicle may be minimized and an effect of preventing motion sickness through the control of the posture depending on the eye gaze of the passenger may be expected.

Also, a shock-absorbing effect by which damage to a passenger can be minimized in the event of an accident or an emergency may be provided, whereby the optimal onboard environment may be provided.

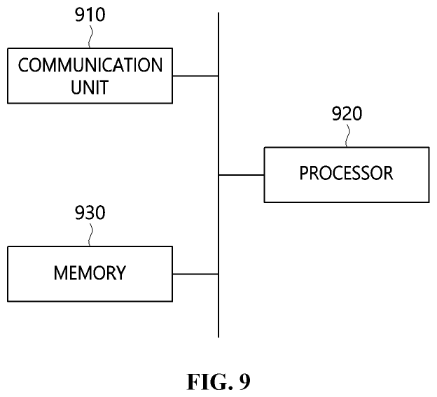

FIG. 9 is a block diagram illustrating an apparatus for controlling the posture of a passenger of an autonomous vehicle according to an embodiment of the present invention.

Referring to FIG. 9, the apparatus for controlling the posture of a passenger of an autonomous vehicle according to an embodiment of the present invention includes a communication unit 910, a processor 920, and memory 930.

The communication unit 910 may serve to transmit and receive information required for controlling the posture of a passenger through a communication network. Here, the network provides a path through which data is delivered between devices, and may be conceptually understood to encompass networks that are currently being used and networks that have yet to be developed.

For example, the network may be an IP network, which provides service for transmission and reception of a large amount of data and uninterrupted data service through an Internet Protocol (IP), an all-IP network, which is an IP network structure that integrates different networks based on IP, or the like, and may be configured as a combination of one or more of a wired network, a Wireless Broadband (WiBro) network, a 3G mobile communication network including WCDMA, a High-Speed Downlink Packet Access (HSDPA) network, a 3.5G mobile communication network including an LTE network, a 4G mobile communication network including LTE advanced, a satellite communication network, and a Wi-Fi network.

Also, the network may be any one of a wired/wireless local area network for providing communication between various kinds of data devices in a limited area, a mobile communication network for providing communication between mobile devices or between a mobile device and the outside thereof, a satellite communication network for providing communication between earth stations using a satellite, and a wired/wireless communication network, or may be a combination of two or more selected therefrom. Meanwhile, the transmission protocol standard for the network is not limited to existing transmission protocol standards, but may include all transmission protocol standards to be developed in the future.

The processor 920 estimates the current state of the autonomous vehicle using multiple types of sensors installed in the autonomous vehicle.

Here, information about the attitude of the autonomous vehicle may be collected using the multiple types of sensors.

Here, the attitude information may include information about the roll, pitch and yaw of the body of the autonomous vehicle.

Here, information about the environment around the autonomous vehicle may be collected using the multiple types of sensors.

Here, the environment information may include the atmospheric pressure, the location information, and the weather information pertaining to the vicinity of the autonomous vehicle.

Here, the current state may be estimated based on the attitude information and the environment information.

Also, the processor 920 measures the posture and the eye gaze of the passenger riding in the autonomous vehicle.

Here, the posture and the eye gaze of the passenger may be measured based on the shape of the seat, the image sensor installed inside the autonomous vehicle, and the pressure sensor installed in the seat of the passenger.

Also, the processor 920 estimates the next control information of the autonomous vehicle based on the autonomous operation information and the current state of the autonomous vehicle.

Also, the processor 920 detects the optimal posture of the passenger in consideration of the next control information and of the posture and the eye gaze of the passenger, and controls the seat such that the passenger matches the optimal posture.

Here, seat control parameters for achieving the optimal posture are calculated, and the seat may be controlled so as to match the seat control parameters.

Here, at least one of the tilt of each part of the seat and the height of the seat may be controlled.

Here, the optimal posture is detected at a preset control period, and when the optimal posture is changed, the seat may be controlled so as to match the changed optimal posture.

The memory 930 stores at least one of the current state, the next control information, and the optimal posture.

Also, the memory 930 stores various kinds of information generated in the above-described apparatus for controlling the posture of a passenger according to an embodiment of the present invention.

According to an embodiment, the memory 930 may be separate from the apparatus for controlling the posture of a passenger, and may support the function for controlling the posture of a passenger. Here, the memory 930 may operate as separate mass storage, and may include a control function for performing operations.

Meanwhile, the apparatus for controlling the posture of a passenger includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage device.

Using the above-described apparatus for controlling the posture of a passenger, the optimal posture for actively providing the optimal onboard environment depending on the state of the body of an autonomous car or aircraft and on the posture and the eye gaze of the passenger is calculated, and control may be performed such that the posture of the passenger is changed to the optimal posture.

Also, the posture of the passenger riding in the autonomous vehicle is actively adjusted, whereby comfort may be offered to the passenger.

Also, the damage in the event of an emergency and the anxiety that the passenger can feel when using the autonomous vehicle are significantly reduced, whereby an unintended safety accident may be prevented.

Also, the current state of the vehicle body is accurately detected based not only on the measurement of the state of the autonomous vehicle body but also on measurement data on the surrounding environment, and the attitude of the vehicle body is estimated depending on the arranged operation route, whereby an environment in which the passenger can use the autonomous vehicle more safely may be provided.

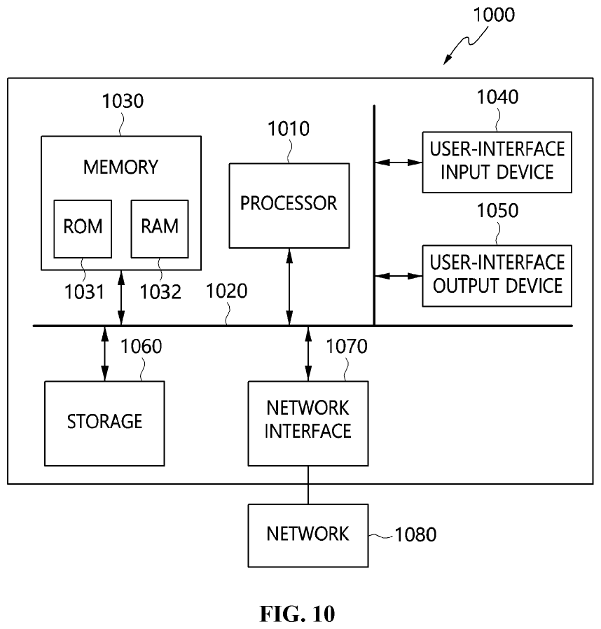

FIG. 10 is a view illustrating a computer system according to an embodiment of the present invention.

Referring to FIG. 10, an embodiment of the present invention may be implemented in a computer system including a computer-readable recording medium. As illustrated in FIG. 10, the computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing processing instructions stored in the memory 1030 or the storage 1060. The memory 1030 and the storage 1060 may be any of various types of volatile or nonvolatile storage media. For example, the memory may include ROM 1031 or RAM 1032.

Accordingly, an embodiment of the present invention may be implemented as a nonvolatile computer-readable storage medium in which methods implemented using a computer or instructions executable in a computer are recorded. When the computer-readable instructions are executed by a processor, the computer-readable instructions may perform a method according to at least one aspect of the present invention.

According to the present invention, the optimal posture for actively providing the optimal onboard environment depending on the state of the body of an autonomous car or aircraft and on the posture and the eye gaze of a passenger may be calculated, and control may be performed such that the posture of the passenger is changed to the optimal posture.

Also, the present invention actively adjusts the posture of a passenger riding in an autonomous vehicle, thereby offering comfort.

Also, the present invention significantly reduces damage in the event of an emergency and the anxiety that a passenger can feel when using an autonomous vehicle, thereby preventing unintended safety accidents.

Also, the present invention correctly detects the current state of an autonomous vehicle body based not only on the measurement of the state of the autonomous vehicle body but also on measurement data on the surrounding environment, and predicts the attitude of the autonomous vehicle body depending on the arranged operation route, thereby providing an environment in which passengers can use the autonomous vehicle more safely.

As described above, the method for controlling the posture of a passenger of an autonomous vehicle and the apparatus using the same according to the present invention are not limitedly applied to the configurations and operations of the above-described embodiments, but all or some of the embodiments may be selectively combined and configured, so that the embodiments may be modified in various ways.

What is claimed is:

1. A method for controlling a posture of a passenger, comprising:
estimating, by a passenger posture control apparatus, a current state of an autonomous vehicle using multiple types of sensors installed in the autonomous vehicle;
measuring, by the passenger posture control apparatus, a posture and an eye gaze of a passenger riding in the autonomous vehicle;
estimating, by the passenger posture control apparatus, next control information of the autonomous vehicle based on autonomous operation information and the current state of the autonomous vehicle; and
detecting, by the passenger posture control apparatus, an optimal posture of the passenger in consideration of the next control information and of the posture and the eye gaze of the passenger, and controlling, by the passenger posture control apparatus, a seat such that the passenger matches the optimal posture.

2. The method of claim 1, wherein measuring the posture and the eye gaze is configured to measure the posture and the eye gaze of the passenger based on a shape of the seat, an image sensor installed inside the autonomous vehicle, and a pressure sensor installed in the seat of the passenger.

3. The method of claim 1, wherein controlling the seat is configured to calculate seat control parameters for achieving the optimal posture and to control the seat so as to match the seat control parameters.

4. The method of claim 1, wherein estimating the current state comprises:
collecting information about an attitude of the autonomous vehicle based on the multiple types of sensors;
collecting information about an environment around the autonomous vehicle based on the multiple types of sensors; and
estimating the current state based on the information about the attitude and the information about the environment.

5. The method of claim 4, wherein the information about the attitude includes a roll, a pitch, and a yaw of a body of the autonomous vehicle.

6. The method of claim 4, wherein the information about the environment includes an atmospheric pressure, location information, and weather information pertaining to a vicinity of the autonomous vehicle.

7. The method of claim 1, wherein controlling the seat is configured to detect the optimal posture at a preset control period and to control, when the optimal posture is changed, the seat so as to match the changed optimal posture.

8. The method of claim 1, wherein controlling the seat is configured to, when a change equal to or greater than a preset reference change rate occurs in the current state of the autonomous vehicle, control the seat so as to match an optimal posture, which is extracted in consideration of the change in the current state.

9. The method of claim 3, wherein controlling the seat is configured to control at least one of a tilt of each part of the seat and a height of the seat.

10. An apparatus for controlling a posture of a passenger, comprising:
a processor for estimating a current state of an autonomous vehicle using multiple types of sensors installed in the autonomous vehicle, measuring a posture and an eye gaze of a passenger riding in the autonomous vehicle, estimating next control information of the autonomous vehicle based on autonomous operation information and the current state of the autonomous vehicle, detecting an optimal posture of the passenger in consideration of the next control information and of the posture and the eye gaze of the passenger, and controlling a seat such that the passenger matches the optimal posture; and
memory for storing at least one of the current state, the next control information, and the optimal posture.

11. The apparatus of claim 10, the processor measures the posture and the eye gaze of the passenger based on a shape of the seat, an image sensor installed inside the autonomous vehicle, and a pressure sensor installed in the seat of the passenger.

12. The apparatus of claim 10, wherein the processor calculates seat control parameters for achieving the optimal posture and controls the seat so as to match the seat control parameters.

13. The apparatus of claim 10, wherein the processor collects information about an attitude of the autonomous vehicle based on the multiple types of sensors, collects information about an environment around the autonomous vehicle based on the multiple types of sensors, and estimates the current state based on the information about the attitude and the information about the environment.

14. The apparatus of claim 13, wherein the information about the attitude includes a roll, a pitch, and a yaw of a body of the autonomous vehicle.

15. The apparatus of claim 13, wherein the information about the environment includes an atmospheric pressure, location information, and weather information pertaining to a vicinity of the autonomous vehicle.

16. The apparatus of claim 10, wherein the processor checks the optimal posture at a preset control period, and when the optimal posture is changed, the processor controls the seat so as to match the changed optimal posture.

17. The apparatus of claim 10, wherein, when a change equal to or greater than a preset reference change rate occurs in the current state of the autonomous vehicle, the processor controls the seat so as to match an optimal posture, which is extracted in consideration of the change in the current state.

18. The apparatus of claim 12, wherein the processor controls at least one of a tilt of each part of the seat and a height of the seat.
